(19) United States
(12) Patent Application Publication
(10) Pub. No.: US 2003/0165738 A1
(43) Pub. Date: Sep. 4, 2003

(54) IMPROVEMENTS TO AN Ni-Zn RECHARGEABLE BATTERY

(76) Inventors: Guy Bronoel, Versailles (FR); Noelle Tassin, Fontenay-Sous-Bois (FR); Alain Millot, Dammarie Les Lys (FR)

Correspondence Address: STURM & FIX LLP, 206 SIXTH AVENUE, SUITE 1213, DES MOINES, IA, 50309-4076, US

(21) Appl. No.: 10/112,374

(22) Filed: Mar. 29, 2002

Related U.S. Application Data
(63) Continuation of application No. PCT/FR00/02659, filed on Sep. 27, 2000.

(30) Foreign Application Priority Data
Sep. 30, 1999 (FR) 99.12338

(51) Int. Cl. H01M 10/26; H01M 6/06; H01M 10/18; H01M 2/16

(52) U.S. Cl. 429/206; 429/300; 429/303; 429/210; 429/255

(57) ABSTRACT

The invention concerns an alkaline Ni-Zn battery comprising both anolyte (E) partially or totally in the form of a viscous phase such as a gel, and catholyte (D) optionally in the form of a viscous phase, a microporous separator (A) between the anolyte and the catholyte, the anolyte and the catholyte having different compositions and volume, and an assembly of bipolar elements. The microporous separator is enclosed between impregnated macroporous separators (F) of the anolyte and the catholyte respectively. The total volume of the anolyte and of the catholyte is contained in the porosity of the macroporous separators and in the porosity of the electrodes. The microporous separator is for example based on cellulose or polypropylene. The inventive Ni-Zn battery has good charging/discharging cycles and low plate resistance.

The invention relates to a Ni-Zn battery, characterised by the use of an alkaline anolyte totally or partially in the form of a gel, a catholyte optionally in the form of a viscous phase, the compositions and volumes being different for the anolyte and the catholyte, and the elements of the battery being arranged as a bipolar assembly.

The Patent Application FR 96 02941 filed by the Applicant Company claimed the means capable of providing a large number of charging and discharging cycles for a rechargeable battery comprising a zinc negative electrode. These means essentially consisted in employing a bipolar arrangement for putting the elements in electrical series, using a membrane filtering the zincate ions and, lastly, different volumes and compositions for the anolyte and the catholyte.

It has actually been found that the combination of all these means did indeed make it possible to acquire a long cycling life for rechargeable batteries such as Ni-Zn. However, the use of an anionic-conduction membrane in this case entails two drawbacks. The first relates to the often high cost of ion-exchange membranes, and the second to the increase in internal resistance which they cause.

It is an object of the described invention to overcome these two drawbacks, while retaining the advantages derived from the use of a bipolar arrangement or differences in concentration and volume between the catholyte and the anolyte.

We essentially propose to replace the ion-exchange membrane separating the anolyte and the catholyte by a set of less resistive separators, at least the anolyte being in the form of a viscous phase such as a gel. The employment of an electrolyte in the form of a viscous phase constitutes a non-obvious solution in so far as it is desirable to obtain a low internal resistance for each element of the rechargeable battery. Moreover, we have unexpectedly found that it is possible, although not obligatory, also to use an electrolyte in the form of a viscous phase in contact with the positive electrode. In the latter case, there could have been a fear of rapid oxidation of the organic constituent of the electrolyte in contact with the positive electrode, thereby leading to a decrease in the alkalinity of the catholyte and poisoning of the positive electrode by the oxidation products. It turns out that such a reaction is very limited and consequently not problematic.

Concerning the set of separators between the catholyte and the anolyte, several solutions have been tested with success. In all cases, the choice is guided by the search for a compromise between the separating power between the catholyte and the anolyte and the electrical resistance of this set.

The present invention relates to a Ni-Zn alkaline battery, characterised in that it comprises, at the same time, the anolyte partially or totally in the form of a viscous phase such as a gel, the catholyte optionally in the form of a viscous phase, a microporous separator between the anolyte and the catholyte, different compositions and volumes for the anolyte and the catholyte, and a bipolar assembly of the elements.

According to one characteristic of the invention, the anolyte consists of a viscous phase formed from a potassium hydroxide solution having a concentration of between 3 and 4 M, to which poly(acrylamide-co-acrylic acid) is added in an amount of between 1 and 3 g per 100 cm³ of alkaline solution. The said viscous phase impregnates the pores of the negative electrode and fills the space contained between the negative electrode and the microporous membrane. Good results have been obtained by combining a potassium hydroxide solution with poly(acrylamide-co-acrylic acid), but it is clear that other compounds may be used.

According to another characteristic of the invention, the said viscous phase impregnates only the space contained between the negative electrode and the microporous separator, excluding the pores of the negative electrode which are impregnated with a potassium hydroxide solution having a concentration of between 3 and 4 M.

Concerning the catholyte composition, two variants are possible, one including an electrolyte based on potassium hydroxide with a concentration of between 7 and 10 M, optionally supplemented with lithium hydroxide at a concentration of 0.2 to 2 M, and the other being the same electrolyte which furthermore contains poly(acrylamide-co-acrylic acid) in an amount of between 1 and 3 g per 100 cm³ of alkaline solution.

The anolyte and the catholyte are contained in the pores of the electrodes (respectively the negative electrode of zinc and the positive electrode of nickel) as well as in the pores of the set of separators which is utilised.

The sets of separators being tested always include a microporous membrane enclosed between macroporous separators having a high capacity for electrolyte retention. These separators, which have a fibrous structure, are for example polyamide felts of the VILEDON® FS2119 type marketed by FREUDENBERG. They are impregnated respectively with the catholyte and the anolyte.

The microporous membrane may be a cellulose-based membrane, a sheet of microporous polypropylene of the CELGARD® type, or a microporous sheet obtained by mixing a polymer (for example polyvinyl chloride, polyethylene, etc.) with SiO₂, with the further option of filling the pores with a metal hydroxide, for example nickel hydroxide, obtained by impregnation of the microporous sheet with a solution of a nickel salt (for example nitrate), followed by internal precipitation through immersion in an alkaline solution. In all cases, it is advantageously possible, although not obligatory, for the residual micropores to be impregnated with an electrolyte in the form of a viscous phase.

The electrolyte volumes are determined by the porosity of the electrodes, and by the number of macroporous separators which are used; as already described in the Patent Application FR 96 02941, it is advantageous to provide an excess quantity of electrolyte on the positive-electrode side, which is obtained by juxtaposing several thicknesses of macroporous separator. For instance, using the VILEDON® FS2119 separator in three or four thicknesses on the positive-electrode side makes it possible to provide a volume of catholyte between 3 and 8 cm³/dm² of front surface area, depending on the state of compression of the fibrous separator.

As regards the volume of the anolyte, the Patent Application FR 96 02941 also described that it was advantageous to limit this in order to prevent the loss of active material (zinc hydroxide) by dissolving; in this case, the separator number is limited in order to obtain a volume of anolyte between 1.5 and 3 cm³/dm² of front surface area, depending on the state of compression of the fibrous separator.

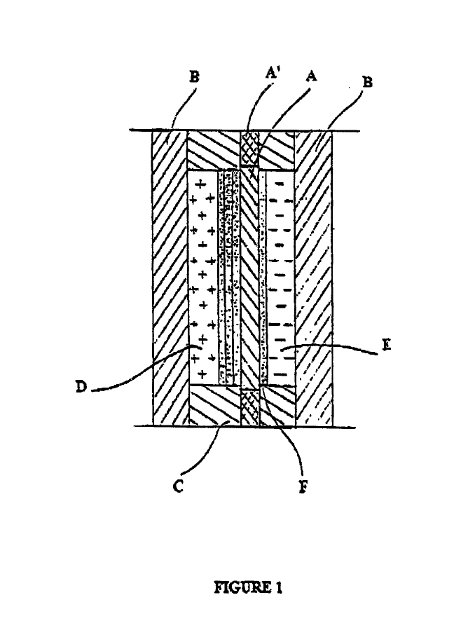

FIG. 1 illustrates an embodiment according to the present invention by way of a non-limiting example. This figure represents only the central element of a poly-element constituting a Ni-Zn battery with a bipolar assembly.

Two compartments can be seen, each of them being contained between a microporous membrane A and a bipolar screen B. This bipolar screen consists of a plate of polymer-carbon composite, for example with the reference RTP 687 (supplier RTP France).

The transverse electrical resistance of the bipolar screen is of the order of 5×10⁻¹ □·cm; the plate having a thickness of 1 mm, the resistance of this plate is equal to 5×10⁻² □ for 1 cm².

The microporous membrane is a sheet of CELGARD® microporous polypropylene, with the reference 3501, the micropores of which are filled with a 3.5 M solution of potassium hydroxide, furthermore containing 2 g of poly(acrylamide-co-acrylic acid) per 100 cm³ of potassium hydroxide solution.

Each compartment is made leaktight by the use of frames C which are welded or adhesively bonded onto the borders of the bipolar screens B and onto the border A′ of the membrane, which does not have any pores at this position.

The nickel positive electrode D has a capacity per unit area of the order of 35 mAh.cm². This electrode is connected to the bipolar screen B by means which have already been described in the Patent Application FR 97 00789.

The space contained between the positive electrode and the microporous membrane is occupied by separators having a fibrous structure of the VILEDON® FS2119 type. After installation, these separators have a total thickness of the order of 0.45 mm. They are impregnated, like the positive electrode, with a solution of 9.8 M potassium hydroxide and 0.2 M lithium hydroxide.

The positive electrode is installed in the discharged state, its conditioning being carried out inside the rechargeable battery; the same is true of the negative electrode. For this reason, valves making it possible to limit the internal pressure are provided for each compartment. Likewise, there is a hole permitting the gases from the anode compartment to pass through towards the cathode compartment, and vice versa. Furthermore, an auxiliary electrode makes it possible to oxidise the hydrogen formed on the negative electrode. These various devices, as well as the free volumes above the electrodes, have not been represented in FIG. 1, these features not being claimed in the present invention because they are already described in the Patent Application FR 96 02941.

The anode compartment comprises a zinc electrode E consisting of a mixture of zinc oxide, calcium hydroxide, an additive based on cadmium, bismuth or indium and a binder such as PTFE. This electrode is pressed onto the bipolar screen B.

The space contained between the negative electrode and the microporous membrane is occupied by a fibrous separator F of the VILEDON® FS2119 type, having a thickness after installation of the order of 0.15 mm. It is impregnated with a viscous solution corresponding to the following composition:

20 g of poly(acrylamide-co-acrylic acid)

1000 cm³ of 3.5 M potassium hydroxide.

A 6.4 V/6 Ah battery was produced according to the example described above, and was subjected to charging and discharging cycles according to the procedure given below:

charging at a rate of 0.22 C with a recharging factor of 1.08,

discharging to an 80% discharge level at a rate of 0.4C.

After 500 charging-discharging cycles under the conditions described above, no degradation of the battery was observed. It is noteworthy that, for a discharging rate of 2 C, the average voltage is 5.34 V (corresponding to 1.35 V per element), i.e. a value which is greater than that obtained with Ni-Zn elements including an anionic membrane.

1. Ni-Zn alkaline battery, characterised in that it comprises, at the same time:
the anolyte partially or totally in the form of a viscous phase such as a gel,
the catholyte optionally in the form of a viscous phase,
a microporous separator between the anolyte and the catholyte,
different compositions and volumes for the anolyte and the catholyte,
a bipolar arrangement of the elements.

2. Ni-Zn alkaline battery according to claim 1, characterised in that the anolyte consists of a viscous phase formed from a potassium hydroxide solution having a concentration of between 3 and 4 M and poly(acrylamide-co-acrylic acid) in an amount of between 1 and 3 g per 100 cm³ of alkaline solution, this viscous phase impregnating the negative electrode and filling the space contained between the negative electrode and the microporous separator.

3. Ni-Zn alkaline battery according to claim 1, characterised in that the anolyte in the form of a viscous phase impregnates only the space contained between the negative electrode and the microporous separator, excluding the pores of the negative electrode which are impregnated with a potassium hydroxide solution having a concentration of between 3 and 4 M.

4. Ni-Zn alkaline battery according to claim 1, characterised in that the catholyte consists of a solution of potassium hydroxide having a concentration of between 7 and 10 M, and optionally lithium hydroxide at a concentration of 0.2 to 2 M.

5. Ni-Zn alkaline battery according to claim 1, characterised in that the catholyte consists of a viscous phase formed from a potassium hydroxide solution having a concentration of between 7 and 10 M, and optionally lithium hydroxide at a concentration of 0.2 to 2 M, supplemented with poly(acrylamide-co-acrylic acid) in an amount of between 1 and 3 g per 100 cm³ of alkaline solution.

6. Ni-Zn alkaline battery according to claim 1, characterised in that the microporous separator is enclosed between macroporous separators impregnated respectively with the catholyte and the anolyte.

7. Ni-Zn alkaline battery according to claims 2 and 3, characterised in that the volume of the anolyte impregnating the macroporous separator which occupies the space between the negative electrode and the microporous membrane is between 1.5 and 3 cm³ per dm² of electrode front surface area.

8. Ni-Zn alkaline battery according to claims 4 and 5, characterised in that the volume of the catholyte impregnating the macroporous separator which occupies the space between the positive electrode and the microporous membrane is between 3 and 8 cm³ per dm² of front surface area.

9. Ni-Zn alkaline battery according to claim 1, characterised in that the microporous separator is a microporous membrane whose initial pores have been filled with nickel hydroxide.

10. Ni-Zn alkaline battery according to claim 1, characterised in that the microporous separator is a microporous membrane made of polypropylene, of the CELGARD® type.

11. Ni-Zn alkaline battery according to claim 1, characterised in that the microporous separator is based on cellulose.

12. Ni-Zn alkaline battery according to claims 9, 10 and 11, characterised in that the residual micropores of the microporous separator are filled with the anolyte in the viscous phase.

13. (New) Ni-Zn alkaline battery comprising, at the same time:
the anolyte partially or totally in the form of a viscous phase such as a gel,
the catholyte optionally in the form of a viscous phase,
a microporous separator between the anolyte and the catholyte, and
different compositions and volumes for the anolyte and the catholyte,
a bipolar arrangement of the elements.

14. (New) Ni-Zn alkaline battery according to claim 13, wherein the anolyte consists of a viscous phase formed from a potassium hydroxide solution having a concentration of between 3 and 4 M and poly(acrylamide-co-acrylic acid) in an amount of between 1 and 3 g per 100 cm³ of alkaline solution, this viscous phase impregnating the negative electrode and filling the space contained between the negative electrode is and the microporous separator.

15. (New) Ni-Zn alkaline battery according to claim 13, wherein the anolyte in the form of a viscous phase impregnates only the space contained between the negative electrode and the microporous separator, excluding the pores of the negative electrode which are impregnated with a potassium hydroxide solution having a concentration of between 3 and 4 M.

16. (New) Ni-Zn alkaline battery according to claim 13, wherein the catholyte consists of a solution of potassium hydroxide having a concentration of between 7 and 10 M, and optionally lithium hydroxide at a concentration of 0.2 to 2 M.

17. (New) Ni-Zn alkaline battery according to claim 13, wherein the catholyte consists of a viscous phase formed from a potassium hydroxide solution having a concentration of between 7 and 10 M, and optionally lithium hydroxide at a concentration of 0.2 to 2 M, supplemented with poly(acrylamide-co-acrylic acid) in an amount of between 1 and 3 g per 100 cm³ of alkaline solution.

18. (New) Ni-Zn alkaline battery according to claim 13, wherein the microporous separator is enclosed between macroporous separators impregnated respectively with the catholyte and the anolyte.

19. (New) Ni-Zn alkaline battery according to claim 14, wherein the volume of the anolyte impregnating the macroporous separator which occupies the space between the negative electrode and the microporous membrane is between 1.5 and 3 cm³ per dm² of electrode front surface area.

20. (New) Ni-Zn alkaline battery according to claim 15, wherein the volume of the anolyte impregnating the macroporous separator which occupies the space between the negative electrode and the microporous membrane is between 1.5 and 3 cm³ per dm² of electrode front surface area.

21. (New) Ni-Zn alkaline battery according to claim 16, wherein the volume of the catholyte impregnating the macroporous separator which occupies the space between the positive electrode and the microporous membrane is between 3 and 8 cm³ per dm² of front surface area.

22. (New) Ni-Zn alkaline battery according to claim 17, wherein the volume of the catholyte impregnating the macroporous separator which occupies the space between the positive electrode and the microporous membrane is between 3 and 8 cm³ per dm² of front surface area.

23. (New) Ni-Zn alkaline battery according to claim 13, wherein the microporous separator is a microporous membrane whose initial pores have been filled with nickel hydroxide.

24. (New) Ni-Zn alkaline battery according to claim 13, wherein the microporous separator is a microporous membrane made of polypropylene, of the CELGARD® type.

25. (New) Ni-Zn alkaline battery according to claim 13, wherein the microporous separator is based on cellulose.

26. (New) Ni-Zn alkaline battery according to claim 23, wherein the residual micropores of the microporous separator are filled with the anolyte in the viscous phase.

27. (New) Ni-Zn alkaline battery according to claim 24, wherein the residual micropores of the microporous separator are filled with the anolyte in the viscous phase.

28. (New) Ni-Zn alkaline battery according to claim 25, wherein the residual micropores of the microporous separator are filled with the anolyte in the viscous phase.
